(19) United States
(12) Patent Application Publication
(10) Pub. No.: US 2006/0224418 A1
(43) Pub. Date: Oct. 5, 2006

(54) Medical services system and method

(76) Inventor: Valery Vinarov, Palatine, IL (US)

Correspondence Address: CARDINAL LAW GROUP, Suite 2000, 1603 Orrington Avenue, Evanston, IL, 60201, US

(21) Appl. No.: 11/396,846

(22) Filed: Apr. 3, 2006

Related U.S. Application Data
(60) Provisional application No. 60/667,301, filed on Apr. 1, 2005.

(51) Int. Cl. G06Q 10/00

(52) U.S. Cl. 705/2

(57) ABSTRACT

A patient care and billing integrated system employs a front-end interface for a real-time simultaneous collection of patient information, and a back end-interface operably connected to the front-end interface for a real-time simultaneous distribution of the patient information for OSS purposes.

### RELATED APPLICATION DATA

This application claims the benefit of U.S. Provisional Application Ser. No. 60/667,301 filed on Apr. 1, 2005. The entirety of the application is hereby incorporated by reference.

### TECHNICAL FIELD OF THE INVENTION

This invention relates to systems, methods and devices for providing medical services.

### BACKGROUND OF THE INVENTION

Currently, a loss or revenue in a patient acquisition and care system is due to various factors including an unclear patient service and quality offering, separate systems for billing, inventory control, medial record and treatment that are not in real-time, lack of attention to patient needs due to poor doctor time management and inefficient provisioning.

Similarly, a loss of revenue in a billing system consisting of an account manager for billing, invoicing and settling is due to various factors including a lack of synchronization between patient acquisition/care systems and billing systems, a lack of real-time billing and adjustment capabilities, incorrect rates or service tariffs, confusing invoices and statements, incorrect data interpretation, and lack of real-time accounting and incomplete billing of doctors' time.

### SUMMARY OF THE INVENTION

One form of the present invention is a patient care and billing integrated system comprising a front-end interface for a real-time simultaneous collection of patient information and a back end-interface for a real-time simultaneous distribution of the patient information for OSS purposes.

The aforementioned form and other forms as well as objects and advantages of the present invention will become further apparent from the following detailed description of various embodiments of the present invention read in conjunction with the accompanying drawings. The detailed description and drawings of the various embodiments of the present invention are merely illustrative of the present invention rather than limiting, the scope of the present invention being defined by the appended claims and equivalents thereof.

### DESCRIPTION OF THE DRAWINGS

FIG. 1 illustrates a patient care and billing integrated system in accordance with the present invention;

FIG. 2 illustrates a patient card in accordance with the present invention;

FIG. 3 illustrates a network in accordance with the present invention;

FIGS. 4 and 5 illustrate a foldable display mobile device in accordance with the present invention; and

Exhibit A includes a specific embodiment of a method and system for providing medical services relating to the treatment of dialysis patients.

### DETAILED EMBODIMENTS OF THE INVENTION

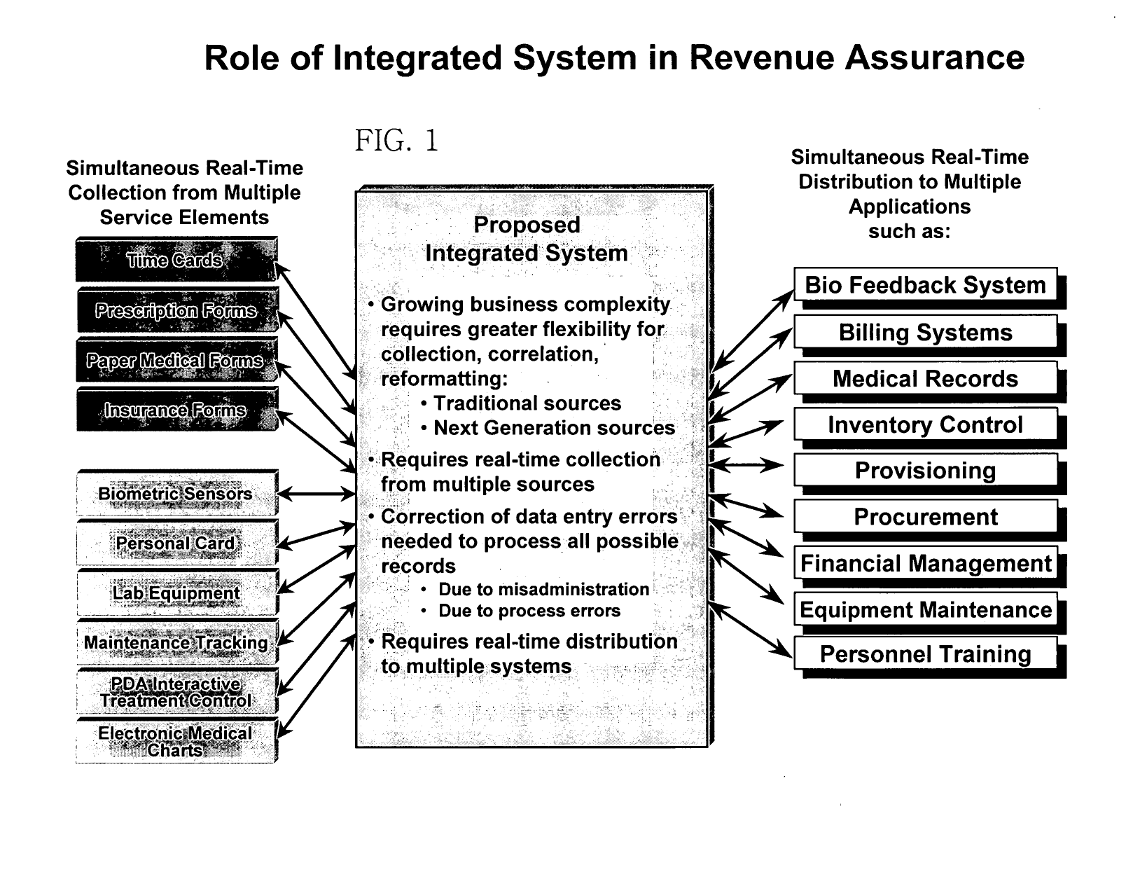

FIG. 1 illustrates a patient care and billing integrated system 10 employing a front-end interface 20 and a back end interface 30. The front-end interface 20 simultaneously collects patient information in real-time from a variety of sources including, but not limited to, a time card input, a prescription form input, a paper medical form input and an insurance form input, a biometric sensor, a personal card, a lab equipment, a maintenance tracker, a PDA interactive treatment controller, and an electronic medial chart. The back-end interface 30 simultaneously distributes patient information in real-time to a variety of applications including, but not limited to, a bio feedback system, a billing system, a medical record system, an inventory control system, a provisioning system, a procurement system, a financial management system, an equipment maintenance system and a personal training system. System 30 further employs means for correcting any errors to the patient information.

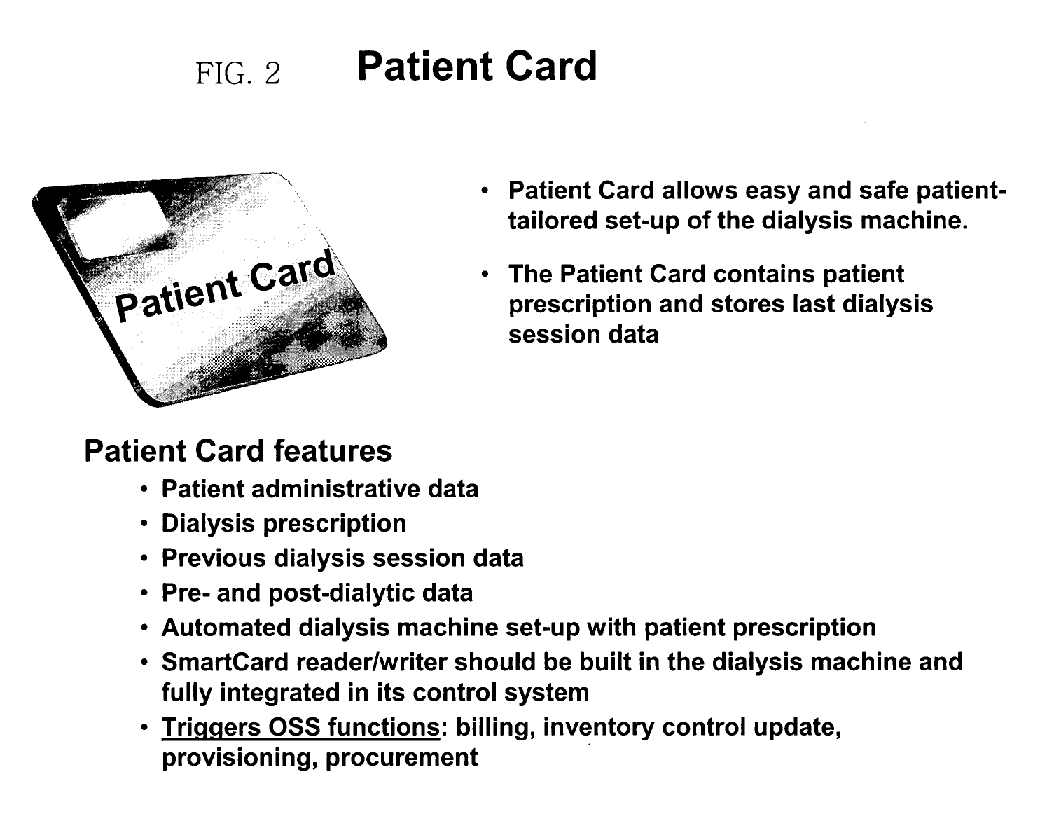

FIG. 2 illustrates a patient card 50 for triggering OSS functions including, a patient card operable to OSS functions including, but not limited to a patient billing, an inventory control update, a provisioning and a procurement. To this end, patient card 50 can include patient administrative data and medial treatment data.

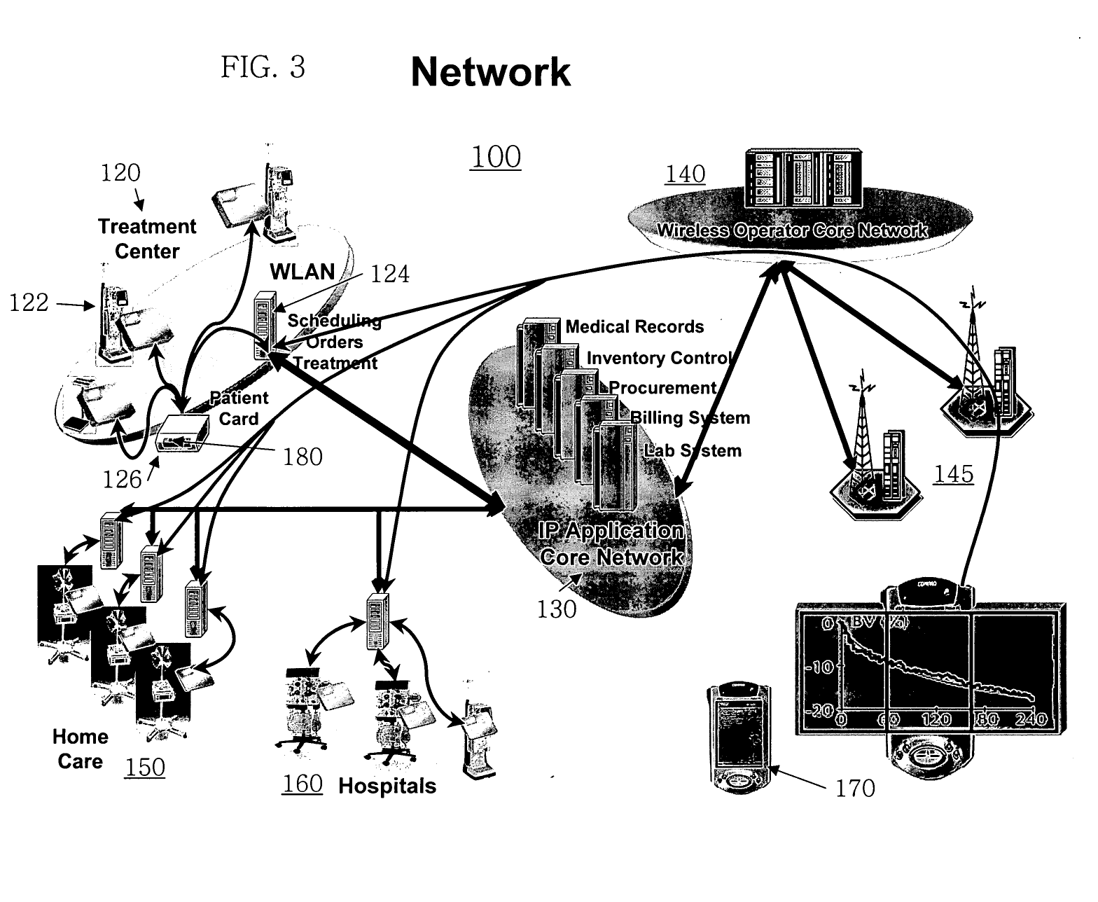

FIG. 3 illustrates medical services network 100 including treatment center 120, IP application core network 130, wireless operator core network 140 and mobile terminal 170. Medical service network 100 may also include at least one home care treatment center 150 and at lest one hospital 160. Treatment center 120 includes medical device 122 having hardware and software for communicating with application server 124. In one embodiment, system 100 also includes patient card 180 described in more detail in Exhibit A, attached.

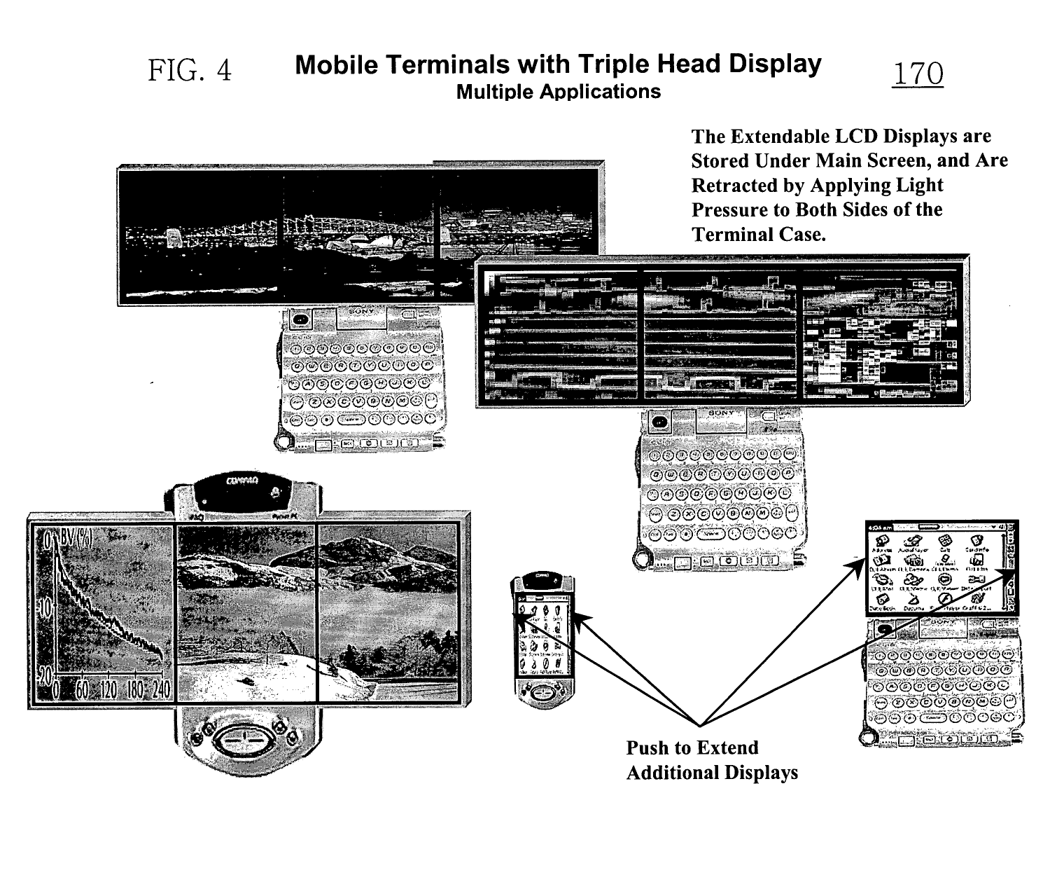

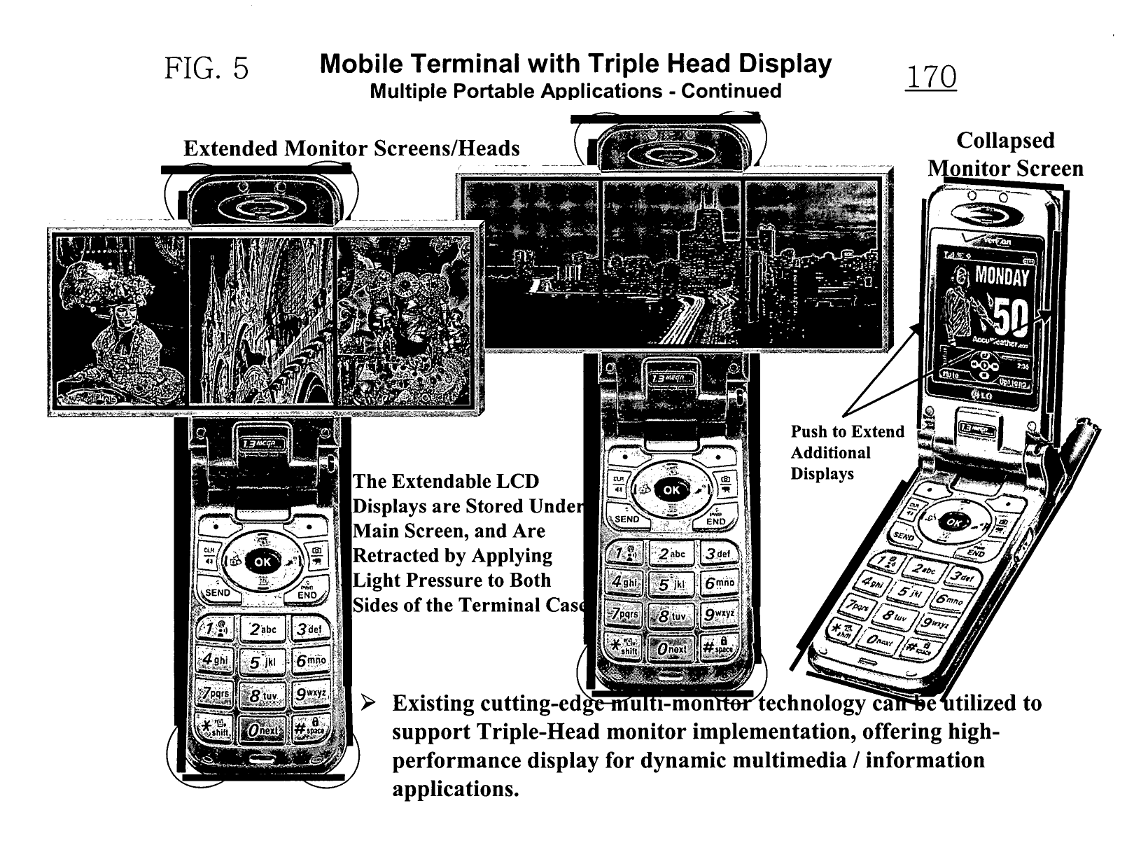

IP application core network 130 is operably connected to treatment center 120, wireless operator core network 140, home care treatment center 150 and hospital 160. IP application core network 130 includes a plurality of systems for sending and retrieving a plurality of records related to providing medical services. IP application core network may include a database for storing medical records, an inventory control system, a procurement system, a billing system and a lab system. IP application core network 130 is operably connected to treatment center 120. Wireless operator core network 140 is operable connected to at least one wireless service provider 145. Home care treatment center 150 includes medical device 152 having the necessary hardware and software for communicating with IP application core network 130 and mobile terminal 170. Mobile terminal 170 may be, for example, a PDA (Personal Digital Assistant) carried by a medical care provider. Mobile terminal 170 may be in wireless communication with treatment center 120, IP application core network 130, home care treatment center 150 and hospital 160. As illustrated in FIGS. 4 and 5, mobile terminal 170 may include a graphical user interface or monitor sized to provide a viewing area large enough for a medical care provider to visualize a large area. In one embodiment, the display is a foldable display.

Patient card 180 may include software and hardware for communicating with various components of system 100, including medical device 122, ip application core network 130 and patient card reader 126. Patient card 180 may include such information as doctor's orders, patient histories, billing information and medical records.

Exhibit A illustrates the use of system 100 in a dialysis treatment facility. System 100 may be used to track inventory, control inventory and procurement, provide accurate and timely billing services and allow the medical care provider to monitor a patient in real time. This ability to monitor a patient in real time allows for better care of the patient and allows the identification of any potential problem in a more timely fashion. In one embodiment, a medical care provider can be sent an alarm if a patient's treatment needs to be amended or stopped based on data received during the treatment. In this embodiment, patient vital signs are monitored and assessed during the treatment of the patient. If the vital signs go outside acceptable levels the doctor can be automatically warned of the situation via the wireless connection of the PDA 170. This automatic alarm provides a more efficient notification of the medical care provider than may be available in a treatment facility that is busy or short staffed.

The system also provides for the automatic billing of the patient as soon as the patient card 180 is inserted in to patient card reader. Inventory and medical records can also be updated upon insertion of the patient care card into the card reader.

I claim:

1. A patient care and billing integrated system, comprising
a front-end interface for a real-time simultaneous collection of patient information; and
a back-end interface operably connected to the front-end interface for a real-time simultaneous distribution of the patient information for OSS purposes.

2. The patient care and billing integrated system of claim 1, wherein the front-end interface is operable to collect the patient information from at least one of a time card input, a prescription form input, a paper medial form input and an insurance form input.

3. The patient care and billing integrated system of claim 1, wherein the front-end interface is operable to receive the patient information from at least one of a biometric sensor, a personal card, a lab equipment, a maintenance tracker, a PDA interactive treatment controller, and an electronic medial charts.

4. The patient care and billing integrated system of claim 1, wherein the back-end interface is operable to distribute the patent information to at least one of a bio feedback system, a billing system, a medical record system, an inventory control system, a provisioning system, a procurement system, a financial management system, an equipment maintenance system and a personal training system.

5. The patient care and billing integrated system of claim 1, further comprising:
means for correcting errors in the patient information.

6. The patient care and billing integrated system of claim 1, further comprising:
a patient card operable to OSS functions including at least one of a patient billing, an inventory control update, a provisioning and a procurement.

7. The patient care and billing integrated system of claim 6, further comprising:
a card reader operable to read and write to the patient card.

8. The patient care and billing integrated system of claim 6, wherein the patient card includes at least one of patient administrative data and medial treatment data.

9. The patient care and billing integrated system of claim 1, further comprising:
a mobile terminal including a graphical user interface for displaying the patient information.

10. The patient care and billing integrated system of claim 9, wherein the mobile terminal has a foldable display operable to display at least one image.

11. A patient care and billing integrated system, comprising
means for a real-time simultaneous collection of patient information; and
means for a real-time simultaneous distribution of the patient information for OSS purposes.

12. A method for integrating a patient care system and a patient billing system, the method comprising:
employing a front-end interface serving as a real-time simultaneous collection of patient information; and
employing a end-interface serving as a real-time simultaneous distribution of the patient information for OSS purposes.
